(19) United States
(12) Patent Application Publication
(10) Pub. No.: US 2025/0264357 A1
(43) Pub. Date: Aug. 21, 2025

(54) DEVICE FOR ANALYZING MATERIAL SAMPLES BY MEANS OF ELECTROMAGNETIC RADIATION WITH SELECTABLE LIGHT SOURCE

(71) Applicant: Nova Industrial Analytics GmbH, Eschach (DE)

(72) Inventor: Joachim MANNHARDT, Eschach (DE)

(73) Assignee: Nova Industrial Analytics GmbH, Eschach (DE)

(21) Appl. No.: 19/202,755

(22) Filed: May 8, 2025

Related U.S. Application Data
(63) Continuation of application No. PCT/EP2023/081135, filed on Nov. 8, 2023.

(30) Foreign Application Priority Data
Nov. 8, 2022 (DE) 10 2022 129 498.6

(51) Int. Cl. G01J 1/04

(52) U.S. Cl. CPC G01J 1/0411

(57) ABSTRACT

A device for analysing material samples by means of electromagnetic radiation. The device comprises an illumination device with at least two radiation sources for generating the electromagnetic radiation, and a deflection element for deflecting the electromagnetic radiation onto the material sample. Furthermore, at least one detector is provided for detecting the electromagnetic radiation emitted by the material sample. The deflection element is designed to be rotatable about an axis parallel to the direction of propagation of the deflected radiation and is movable in such a way that the material sample can be selectively exposed to radiation from one of the radiation sources. Advantageously, the deflection element is designed as a mirror, for example as a concave mirror.

This nonprovisional application is a continuation of International Application No. PCT/EP2023/081135, which was filed on Nov. 8, 2023, and which claims priority to German Patent Application No. 10 2022 129 498.6, which was filed in Germany on Nov. 8, 2022, and which are both herein incorporated by reference.

### BACKGROUND OF THE INVENTION

### Field of the Invention

The invention relates to a device for analyzing material samples via electromagnetic radiation.

### Description of the Background Art

In many fields of industry pertaining to production and further processing, for example medical engineering, the food industry, etc., optical measuring methods are used to assess the state or quality of a product or an intermediate product. The term “optical measuring method” should be understood hereinafter to mean a measuring method using electromagnetic radiation, in particular electromagnetic radiation in a spectral range between infrared and ultraviolet. “Optical measurement” thus includes in particular a measurement in the far infrared (FIR), mid-infrared (MIR) and near infrared (NIR) spectral ranges, in the visible spectral range and in the UV range.

Such measurements are often associated with a desire to analyze the material sample using electromagnetic radiation of different wavelengths. By way of example, for carrying out fluorescence measurements, biochemical samples can be labeled with two or more fluorophores, such that they emit light differently upon excitation with different light wavelengths. Biochemical properties can be measured in this way.

DE 100 38 185 C2, which corresponds to US 2003/0168610, and which discloses a measuring unit comprising two light sources and a detector, wherein the light from the first or the second light source is selectively directed onto a sample carrier by means of a rotatable mirror comprising transparent regions. The light emitted from the sample carrier is then guided onto a detector.

### SUMMARY OF THE INVENTION

It is therefore an object of the present invention to provide a device for analyzing material samples via electromagnetic radiation which can comprise a plurality of radiation sources which can be selectively directed at the material sample. The device is intended to permit a rapid and simple change between the different radiation sources.

A device according to an example of the invention comprises at least two radiation sources for generating electromagnetic radiation, a deflection element for deflecting this radiation onto a material sample situated in an observation region, and at least one detector for detecting the electromagnetic radiation emanating from the material sample. In this case, the deflection element is movable in such a way that the radiation from one radiation source or the radiation from the other radiation source is selectively directed onto the material sample by means of the deflection element. In this case, “directing” or “deflecting” may be understood to mean a change in direction of the radiation emitted by the radiation source. Such a design of the device has the advantage that multiple radiation sources can be provided, which can be used for illuminating the material sample by way of a simple movement of the deflection element.

The deflection element can be mounted rotatably, specifically in such a way that the axis of rotation is oriented parallel to the direction of propagation of the deflected radiation. In this case, the two or multiple radiation sources can be arranged on an arc of a circle around the deflection element, and the radiation from one or the other radiation source can selectively be directed onto the material sample by way of rotations of the deflection element, without further adjustments being necessary.

In a first configuration of the invention, at least two of the radiation sources can be designed in the same way. This makes possible a redundant embodiment of the illumination, in particular in problematic environments in which for example incandescent filaments of halogen lamps or anodes of mercury vapor lamps may crack or break off owing to mechanical loading, vibrations, etc.

Further, at least two of the radiation sources can be designed in different ways, for example radiate in different spectral ranges, with different intensities, etc. This makes it possible to choose a radiation source optimally suited to the respective measurement task. Furthermore, it makes possible a rapid switchover of the radiation source if radiation of different wavelengths is intended to be successively directed onto the material sample for a given measurement task.

The deflection element advantageously can have beam shaping properties. By way of example, the deflection element can be designed in such a way that it focuses the radiation emitted by the radiation source onto the material sample; such a configuration is advantageous especially if small objects are intended to be analyzed. Alternatively, the deflection element can expand (defocus) the beam emitted by the radiation source, which can be advantageous for example in applications of reflection spectroscopy in the visible or infrared spectral range if the material sample is intended to be illuminated over a large area.

The deflection element can comprise a mirror, in particular. By way of example, it is possible to use a parabolic mirror having an advantageous collimation effect for spectroscopic measurements.

The deflection element can have an opening for electromagnetic radiation to be guided through. This is expedient especially if the spectrum or the intensity of the radiation reflected by the material sample in the incidence direction is intended to be measured, for example in the course of determining the intensity or functional testing in transmission measurements. Furthermore, it is advantageous to attach an optical waveguide in the region of this passage opening, said optical waveguide enabling the radiation incident in the opening to be passed on to the detector. It is particularly advantageous to provide a light guide rod in the region of the opening, the radiation reflected by the material sample in the incidence direction being guided through the deflection element with low losses by said light guide rod.

In addition to detecting the radiation reflected by the material sample, it may be desirable to detect the radiation transmitted by the material sample. For this purpose, an optical element can be arranged on the side of the observation region which faces away from the deflection element, the electromagnetic radiation emanating from the material sample being focused with the aid of said optical element. This optical element serves for incoupling the radiation into a fiber connected to a detector, or for direct focusing onto a detector area. Accordingly, at the focus of this optical element, a detector or an end face of an optical waveguide can be arranged, with the aid of which the radiation is passed on to a detector.

For validating measurements and/or for calibrating the device, a validation element can be provided in the beam path between deflection element and material sample. This validation element can be manifested by a white reference or can be a filter or filter wheel, for example, which is advantageously provided with cutouts for transmission measurements.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a schematic perspective view of a device according to the invention for analyzing material samples;

FIG. 2 shows a schematic sectional view of an illumination unit from FIG. 1 according to the sectional line II-II in FIG. 1;

FIG. 3 shows a further schematic sectional view of the illumination unit from FIG. 2 with the deflection element having been rotated;

FIG. 4 shows a schematic perspective view of a device comprising multiple radiation sources and multiple detectors; and

FIG. 5 shows a schematic perspective view of an alternative device comprising multiple radiation sources and multiple detectors.

### DETAILED DESCRIPTION

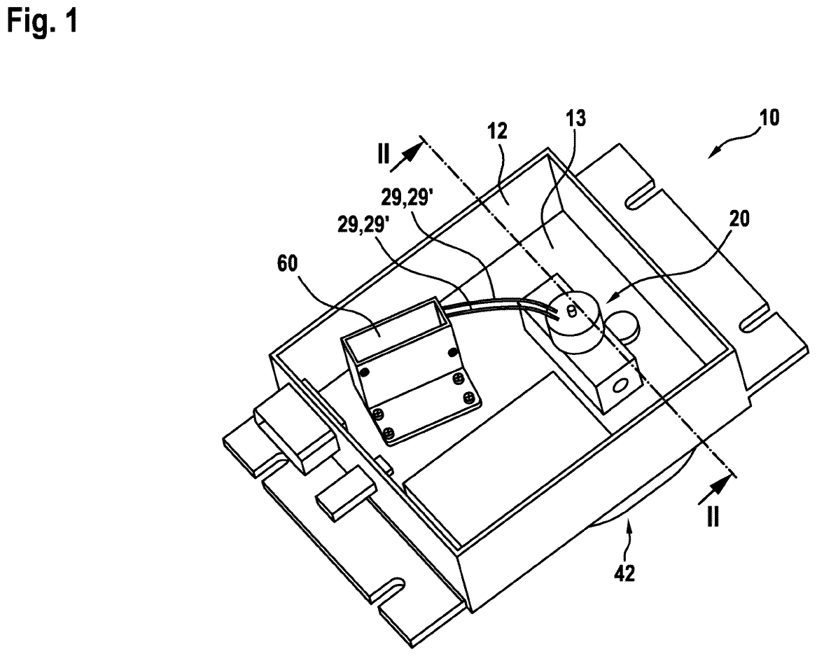

FIG. 1 shows a first example of a device 10 for analyzing material samples by means of electromagnetic radiation. The device 10 comprises a housing 12, in which an illumination unit 20 for generating the electromagnetic radiation and a detector 60 for detecting the electromagnetic radiation emanating from the material sample are arranged. An observation region 42 is situated beneath a baseplate 13 of the housing 12, and the material sample 40 to be analyzed is arranged in said observation region.

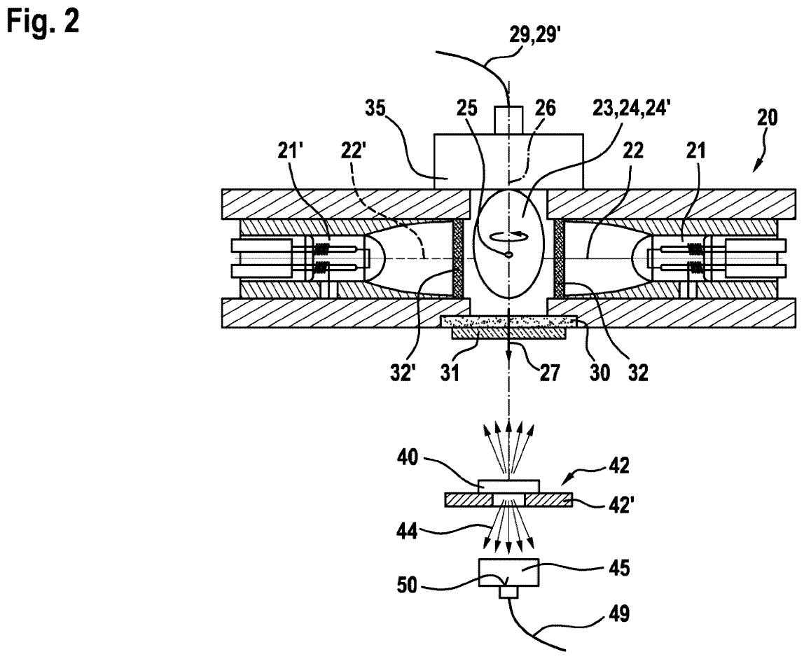

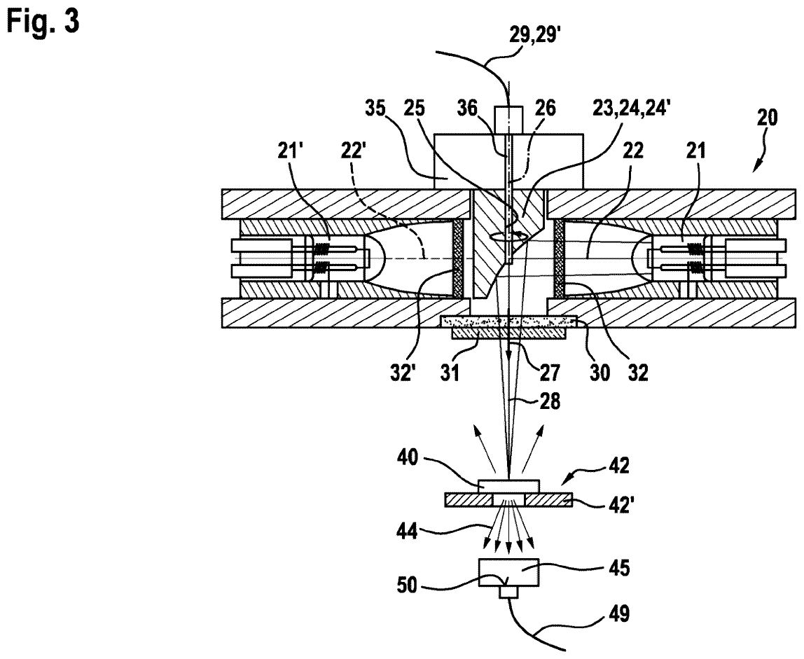

FIG. 2 shows a schematic sectional view of the illumination unit 20. In the present example, the illumination unit 20 comprises two radiation sources 21, 21′, the beams 22, 22′ from which are directed at a deflection element 23. In the present example, the radiation sources 21, 21′ used are halogen lamps provided with different wavelength-selective filters 32, 32′, as a result of which the emerging radiation has different spectral properties. Alternatively, e.g. LEDs having a narrow emission range in different spectral ranges can be used as radiation sources. The two radiation sources 21, 21′ are arranged diametrically opposite one another, such that their respective optical axes are oriented in alignment with one another. The deflection element 23 serves to direct selectively the beams 22 from the first radiation source 21 or the beams 22′ from the second radiation sources 21′ onto the material sample 40, which is arranged on an observation stage 42′ in the observation region 42 beneath the illumination unit 20. The deflection element 23 comprises a mirror 24, in this example, a concave mirror 24′, which can be rotated about an axis 26 of rotation perpendicular to the direction of propagation of the beams 22, 22′. In FIG. 2, the mirror 24 is situated in a central position in which neither light from the radiation source 21 nor light from the radiation source 21′ is directed onto the material sample 40. Rotation of the deflection element 23 about the axis 26 of rotation enables the mirror 24 to be brought into the position shown in FIG. 3, in which the radiation 22 from the first radiation source 21 is deflected with the aid of the mirror 24 and is focused onto the material sample 40, while the radiation 22′ from the second radiation source 21′ is blocked by the deflection element 23. With the aid of the mirror 24, the radiation 21 is reflected in a direction 27 of propagation running parallel—and in the example collinearly—to the axis 26 of rotation of the deflection element 23. A drive unit 35 is provided for the purpose of rotating the mirror 24. With the aid of this drive unit 35, the mirror 24 can be rotated by 180° from the position shown in FIG. 3, such that radiation 22′ from the second radiation source 21′ passes to the material sample 40, while the radiation 22 from the first radiation source 21 is blocked by the deflection element 23. In addition to the radiation sources 21, 21′, even further radiation sources can be present, which are arranged around in a great circle in a plane perpendicular to the axis 26 of rotation of the mirror 24. Rotations of the mirror 24 make it possible—as described above—alternatively for the light from one of these radiation sources to be directed onto the material sample 40.

The rotation of the mirror 24 can take place continuously or step by step. In this regard, by way of a continuous rotation of the mirror 24, radiation from one or the other radiation source 21, 21′ can be directed onto the material sample 40 at regular time intervals. Alternatively, the mirror 24 can be rotated in a positioning manner. In particular, the rotation of the mirror 24 can take place only as required, e.g. in the case where the radiation source 21 fails owing to a defect and a (identical) radiation source 21′ is therefore intended to be used for measuring the material sample 40.

The deflection element 23 is provided with an opening 25, through which radiation reflected by the material sample 40 in the incidence direction 27 can be guided toward the outside. In order to be able to feed this reflected radiation to the detector 60, a light wave rod 36 can be provided in the region of the opening 25. The radiation guided through the deflection element 23 by means of the light wave rod 36 is passed on to the detector 60 using an optical waveguide 29, for example a fiber 29′, and is analyzed at said detector. This reflected radiation can be used for example for determining the intensity in transmission measurements or for determining a spectrum reflected by the material sample 40.

An optical element 45 is provided on a side of the observation region 42 which faces away from the illumination unit 20, the radiation 44 emanating from the material sample 40 or transmitted by the material sample 40 being focused by means of said optical element. An end face 50 of a further optical waveguide 49 can be arranged in the region of the focus of this optical element 45, the radiation 44 being guided into the detector 60 by said further optical waveguide. Alternatively, a further detector can be arranged at the focus of the optical element 45.

The illumination unit 20 is closed off from the surroundings by an observation window 31, in particular a sapphire window, in order to prevent ingress of dust and other contaminants into the interior of the illumination unit. A validation element 30 for calibrating the device 10 and/or for validating measurements can be present in the radiation path 28 downstream of the mirror 24. This validation element 30 can be in particular a white reference or a filter or filter wheel (having a cutout for transmission measurements).

In addition to the two radiation sources 21, 21′ shown in FIG. 2, further radiation sources can be provided, which are arranged jointly with the radiation sources 21, 21′ in a plane perpendicular to the axis 26 of rotation of the deflection element 23, such that their beams can be directed onto the material sample 40 by way of a rotation of the mirror 24.

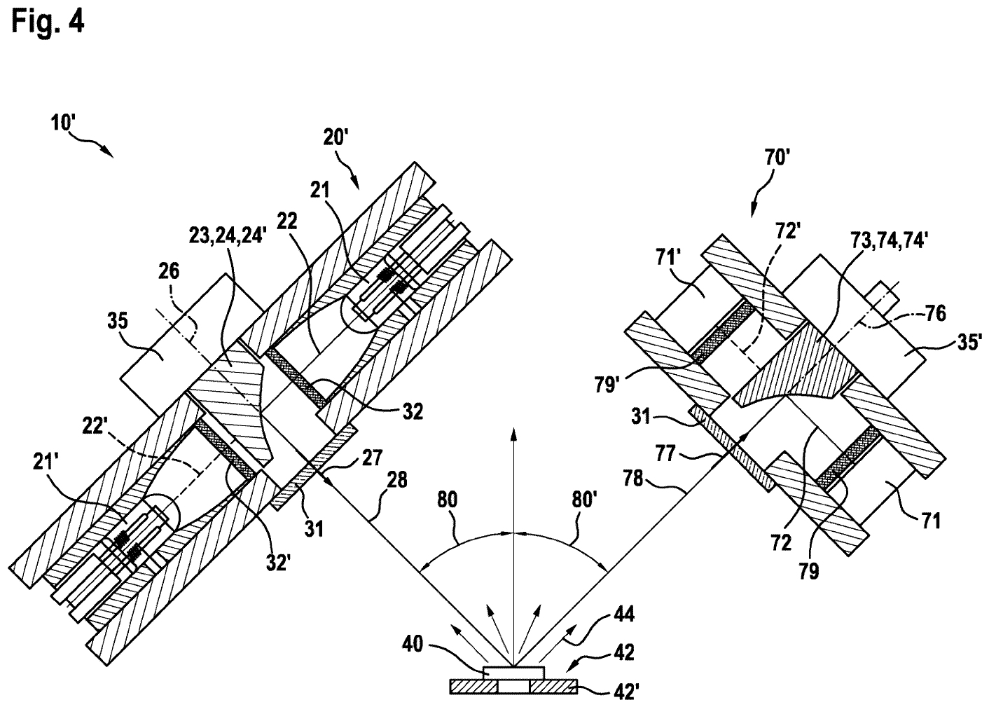

FIG. 4 shows a further device 10′ for analyzing a material sample 40 with the aid of an illumination unit 20′ and a detection unit 70′. The illumination unit 20′ substantially corresponds to the illumination unit comprising two radiation sources 21, 21′ shown in FIGS. 2 and 3 and is tilted at an angle 80 of incidence, for example 45°, relative to the material sample 40. The detection unit 70′ comprises two detectors 71, 71′ and is situated in an angular position tilted at an angle 80′ of reflection relative to the material sample 40. The radiation 78 emitted by the material sample 40 in radiation direction 77 can be selectively directed onto one of the two detectors 71, 71′ by a deflection unit 73 integrated in the detection unit 70′. The deflection unit 73 comprises a mirror 74, in the present case a concave mirror 74′. In order to direct the beam 78 onto one or the other detector 71, 71′, the mirror 74 can be rotated about an axis 76 of rotation with the aid of a drive unit 35′. In FIG. 4, the mirror 24 is situated in a position in which the radiation 78 reflected in direction 80′ by the material sample 40 is focused onto the detector 71 via the mirror 74, while the second detector 71′ is shielded from the radiation 78 by the deflection element 73. A rotation of the mirror 74′ by 180° directs the radiation 78 onto the second detector 71′, while the first detector 71 is shielded. Choosing suitable wavelength-selective filters 79, 79′ arranged in front of the detectors 71, 71′ makes it possible to measure the intensity of the radiation 78 in different wavelength ranges by means of the detectors 71, 71′.

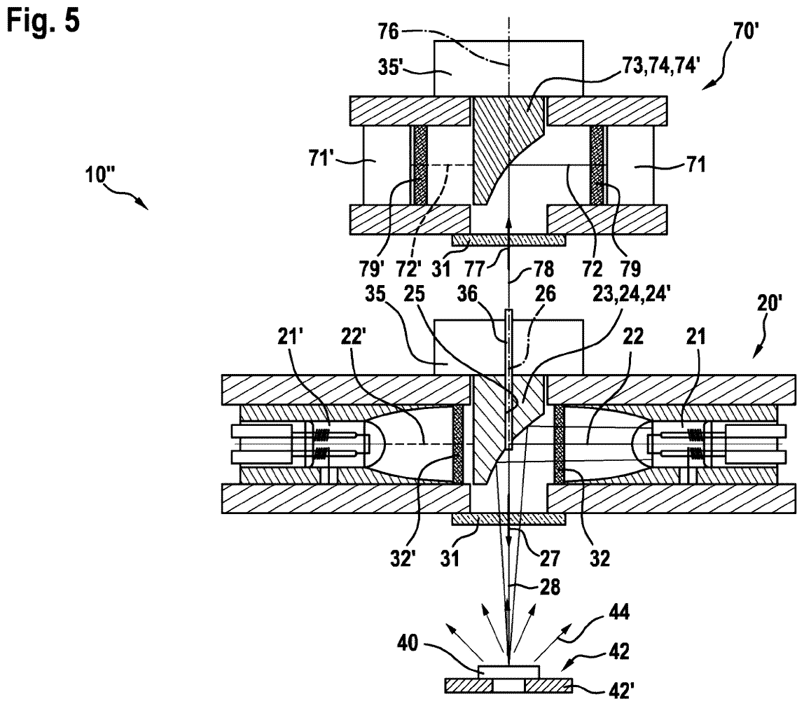

FIG. 5 shows a device 10″ for analyzing a material sample 40 with the aid of the illumination unit 20′ and the detection unit 70′, both of which are arranged perpendicular to the material sample 40 in this example. The material sample 40 can be illuminated selectively with radiation from the radiation source 21 or the radiation source 21′ by means of the illumination unit 20′. The radiation 78 reflected by the material sample 40 in incidence direction 27 is guided through the deflection element 23 of the illumination unit 20′ by means of a light guide rod 36 and impinges on the detection unit 70′, in which the radiation 78 can be selectively directed onto the detector 71 or the detector 72.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A device for analyzing material samples via electromagnetic radiation, the device comprising:
at least two radiation sources to generate the electromagnetic radiation;
a deflection element to deflect the electromagnetic radiation onto the material sample, radiation from at least one of the at least two radiation sources being selectively directable onto the material sample via the deflection element; and
at least one detector to detect the electromagnetic radiation emanating from the material sample,
wherein the deflection element is rotatable about an axis substantially parallel to a direction of propagation of the deflected radiation.

2. The device as claimed in claim 1, wherein the at least two of the radiation sources are substantially the same.

3. The device as claimed in claim 1, wherein the at least two of the radiation sources are designed in different ways.

4. The device as claimed in claim 1, wherein the deflection element has beam shaping properties.

5. The device as claimed in claim 4, wherein the deflection element has a focusing effect on the radiation.

6. The device as claimed in claim 4, wherein the deflection element has a defocusing effect on the radiation.

7. The device as claimed in claim 1, wherein the deflection element comprises a mirror, via which radiation from one of the radiation sources is selectively directable onto the material sample.

8. The device as claimed in claim 7, wherein the mirror is a concave mirror.

9. The device as claimed in claim 1, wherein the deflection element has an opening for passage of electromagnetic radiation.

10. The device as claimed in claim 9, wherein an end face of an optical waveguide or a fiber is arranged in a region of the opening.

11. The device as claimed in claim 9, wherein a light guide rod is arranged in a region of the opening.

12. The device as claimed in claim 1, wherein an optical element for focusing the electromagnetic radiation emanating from the material sample is arranged on a side of the observation region provided for the material sample which faces away from the deflection element.

13. The device as claimed in claim 12, wherein a detector is arranged in a region of a focus of the optical element.

14. The device as claimed in claim 12, wherein an end face of an optical waveguide is arranged in the region of the focus of the optical element.

15. The device as claimed in claim 1, wherein a validation element for calibrating the device and/or for validating measurements is present in the radiation path downstream of the deflection element.
